(19) United States
(12) Patent Application Publication
(10) Pub. No.: US 2025/0293230 A1
(43) Pub. Date: Sep. 18, 2025

(54) SOLID-STATE BATTERY AND SOLID ELECTROLYTE

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 18/971,787

(22) Filed: Dec. 6, 2024

(30) Foreign Application Priority Data
Mar. 13, 2024 (JP) 2024-038994

(51) Int. Cl. H01M 4/04; H01M 4/02; H01M 4/38; H01M 10/0525; H01M 10/0562

(52) U.S. Cl. CPC H01M 4/0407; H01M 4/386; H01M 10/0525; H01M 10/0562; H01M 2004/027; H01M 2300/008

(57) ABSTRACT

The present disclosure provides a solid-state battery including: a positive electrode active material layer; a negative electrode active material layer; and a solid electrolyte layer that is disposed between the positive electrode active material layer and the negative electrode active material layer, in which: at least one of the positive electrode active material layer, the negative electrode active material layer, and the solid electrolyte layer contains a solid electrolyte; and the solid electrolyte contains an Li element, an Al element, an M element (M is at least one kind of B, Ga, In, and Tl), and a halogen element, and contains the halogen element as a main component of an anion.

### CROSS-REFERENCE TO RELATED APPLICATION

This application claims priority to Japanese Patent Application No. 2024-038994 filed on Mar. 13, 2024, incorporated herein by reference in its entirety.

### BACKGROUND

### 1. Technical Field

The present disclosure relates to a solid-state battery and a solid electrolyte.

### 2. Description of Related Art

In recent years, the development of batteries has been actively performed. For example, in the automobile industry, the development of a battery that is used in a battery electric vehicle (BEV), a plug-in hybrid electric vehicle (PHEV), or a hybrid electric vehicle (HEV) has been advanced. Further, the development of a member and a material that are used in the above battery has been advanced.

For example, Japanese Unexamined Patent Application Publication No. 2023-120474 discloses a lithium ion conductor containing LiBI₄, as a solid electrolyte that is used in the battery.

### SUMMARY

From a standpoint of the enhancement in battery performance, it is desirable that charge-discharge efficiency (coulombic efficiency) is high. The present disclosure has been made in view of the above circumstance, and has a main object to provide a solid-state battery that has a high charge-discharge efficiency.

[1] A solid-state battery comprising:
a positive electrode active material layer;
a negative electrode active material layer; and
a solid electrolyte layer that is disposed between the positive electrode active material layer and the negative electrode active material layer, wherein:
at least one of the positive electrode active material layer, the negative electrode active material layer, and the solid electrolyte layer contains a solid electrolyte; and
the solid electrolyte contains an Li element, an Al element, an M element (M is at least one kind of B, Ga, In, and Tl), and a halogen element, and contains the halogen element as a main component of an anion.

[2] The solid-state battery according to [1], wherein a ratio of the M element to a total of the Al element and the M element is 10% or more and 80% or less, in the solid electrolyte.

[3] The solid-state battery according to [1] or [2], wherein the solid electrolyte contains an I element as the halogen element.

[4] The solid-state battery according to any one of [1] to [3], wherein the negative electrode active material layer contains an Si-based negative electrode active material.

[5] A solid electrolyte that is used in a solid-state battery, wherein the solid electrolyte contains an Li element, an Al element, an M element (M is at least one kind of B, Ga, In, and Tl), and a halogen element, and contains the halogen element as a main component of an anion.

The present disclosure exerts an effect of providing a solid-state battery that has a high charge-discharge efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a solid-state battery in the present disclosure.

### DETAILED DESCRIPTION OF EMBODIMENTS

A solid-state battery and a solid electrolyte in the present disclosure will be described below in detail.

### A. Solid-State Battery

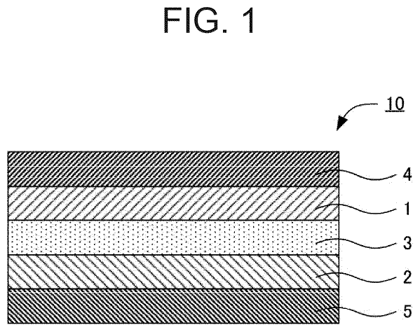

FIG. 1 is a schematic sectional view illustrating a solid-state battery in the present disclosure. FIG. 1 schematically shows the solid-state battery in the present disclosure, and to facilitate understanding, sizes and shapes of each portion are exaggeratingly shown when appropriate. A solid-state battery 10 shown in FIG. 1 includes a positive electrode active material layer 1, a negative electrode active material layer 2, and a solid electrolyte layer 3 that is disposed between the positive electrode active material layer 1 and the negative electrode active material layer 2. Further, the solid-state battery 10 includes a positive electrode current collector 4 that collects electrons in the positive electrode active material layer 1, and a negative electrode current collector 5 that collects electrons in the negative electrode active material layer 2. Particularly, in the solid-state battery 10, at least one of the positive electrode active material layer 1, the negative electrode active material layer 2, and the solid electrolyte layer 3 contains a solid electrolyte. The solid electrolyte contains an Li element, an Al element, an M element (M is at least one kind of B, Ga, In, and Tl), and a halogen element, and contains the halogen element as a main component of an anion.

In the present disclosure, at least one of the positive electrode active material layer, the negative electrode active material layer, and the solid electrolyte layer contains a predetermined solid electrolyte, and therefore, the solid-state battery has a high charge-discharge efficiency.

As the solid electrolyte that is used in the solid-state battery, for example, a LiAl halide salt such as LiAlI₄ has been studied. Meanwhile, the inventor has known that the charge-discharge efficiency (cycle characteristic) decreases in the solid-state battery in which the LiAl halide salt is used. Although details are not known, it is estimated that the repeat of the charge and discharge of the battery causes the reductive decomposition of the LiAl halide salt. In this regard, as a result of diligent study, the inventor has found that a solid-state battery having a high charge-discharge efficiency can be obtained in the case of the use of a solid electrolyte in which a group 13 element other than Al is added to the LiAl halide salt. Although details are not known, it is estimated that the addition of the group 13 element other than Al forms a stable reduction product on the surface of the solid electrolyte and restrain the reductive decomposition of the whole solid electrolyte.

### 1. Solid Electrolyte

The solid electrolyte in the present disclosure contains the Li element, the Al element, the M element (M is at least one kind of B, Ga, In, and Tl), and the halogen element, and contains the halogen element as the main component of the anion. The solid electrolyte in the present disclosure corresponds to a so-called LiAl halide-based salt.

The ratio of the total of the Li element, the Al element, the halogen element, and the M element to all elements contained in the solid electrolyte may be 100 mol %, or may be less than 100 mol %. The ratio of the total of the Li element, the Al element, the halogen element, and the M element is 70 mol % or more, for example, and may be 80 mol % or more, or may be 90 mol % or more.

Examples of the halogen element include F, Cl, B, and I. The solid electrolyte may contain one kind of halogen element, or may contain two or more kinds of halogen elements. Particularly, it is preferable that the solid electrolyte contains at least the I element. Further, the above halogen element is contained as the main component of the anion. “Containing as the main component of the anion component” means that the ratio of the above halogen element to all anion components contained in the solid electrolyte is 50 mol % or more. The ratio of the above halogen element to all anion components may be 100 mol %, and may be less than 100 mol %.

The M element is at least one kind of B, Ga, In, and Tl. The solid electrolyte may contain one kind of M element, or may contain two or more kinds of M elements. Particularly, it is preferable that the solid electrolyte contains at least Ga. Further, in the solid electrolyte, the ratio (mole ratio) of the M element to the total of the Al element and the M element is 10% or more, for example, and may be 20% or more, may be 30% or more, or may be 40% or more. On the other hand, the ratio of the M element is 80% or less, for example, and may be 60% or less, or may be 50% or less. When the ratio of the M element is too small, there is a fear that it is not possible to sufficiently get the effect of the restraint of the reductive decomposition of the solid electrolyte. When the ratio of the M element is too large, there is a fear that it is not possible to get a high ion conductivity.

It is preferable that the solid electrolyte in the present disclosure does not contain a sulfur element (S element). This is because the water resistance of the solid electrolyte becomes high.

An example of the composition of the solid electrolyte includes LiAl₁₋ₐMₐX₄ (0.1≤a≤0.8). M is the above-described M element, and X is the above-described halogen element. Further, a may be 0.2 or more, may be 0.3 or more, or may be 0.4 or more. On the other hand, a may be 0.7 or less, may be 0.6 or less, or may be 0.5 or less. The solid electrolyte expressed as the above composition can be regarded as a salt in which the M element is substituted for some of Al in the LiAl halide salt.

The melting point of the solid electrolyte is 300° C. or lower, for example, and may be 200° C. or lower, or may be 150° C. or lower. On the other hand, the melting point is 10° C. or higher, for example, and may be 50° C. or higher. The melting point can be measured by differential scanning calorimetry (DSC measurement). A solid electrolyte having a melting point of 100° C. or lower is also called a molten salt. At the time of charge and discharge, the solid electrolyte in the present disclosure may be in a molten state, or may be in a solid state.

The ion conductivity of the solid electrolyte at 25° C. is not particularly limited, but preferably should be high. For example, the ion conductivity is 1.0×10⁻⁶ S/cm or higher and 1.0×10⁻⁴ S/cm or lower.

The solid electrolyte may include only one crystal phase, or may include two or more crystal phases. Examples of the crystal phase in the case of the former include a crystal phase that is expressed as the above-described composition. Examples of the crystal phases in the case of the latter include the crystal phase that is expressed as the above-described composition, a crystal phase with an LiAl halide such as LiAlI₄, and a crystal phase with an LiM halide such as LiGaI₄.

Further, in the solid-state battery, the solid electrolyte in the present disclosure is contained in at least one of the positive electrode active material layer, the negative electrode active material layer, and the solid electrolyte layer. The solid electrolyte may be contained in one layer of the positive electrode active material layer, the negative electrode active material layer, and the solid electrode layer, may be contained in two layers, or may be contained in three layers.

### 2. Positive Electrode Active Material Layer

The positive electrode active material layer contains at least a positive electrode active material.

Examples of the positive electrode active material include an oxide active material. Examples of the oxide active material include a bedded salt-type active material such as LiNi_{1/3}Co_{1/3}Mn_{1/3}O₂ and LiNi_{0.8}Co_{0.15}Al_{0.05}O₂, a spinel-type active material such as LiMn₂O₄, and an olivine-type active material such as LiFePO₄. Further, sulfur(S) may be used as the positive electrode active material.

The form of the positive electrode active material is a particle form, for example. The average particle diameter (D₅₀) of the positive electrode active material is 0.5 μm or more and 50 μm or less, for example. The average particle diameter (D₅₀) is a volume accumulation particle diameter that is measured by a laser diffraction-diffusion type particle size distribution measuring device. The ratio of the positive electrode active material in the positive electrode active material layer is 50 weight % or more and 80 weight % or less, for example.

The positive electrode active material layer may contain at least one of an electrolyte, a conductive material, and a binder, as necessary. It is preferable that the positive electrode active material layer contains the solid electrolyte described in “1. Solid Electrolyte”, as the electrolyte. Further, the positive electrode active material may contain an electrolyte (another electrolyte) other than the above-described solid electrolyte. The other electrolyte will be described in “4. Solid Electrolyte Layer”. The ratio of the solid electrolyte in the positive electrolyte active material layer is 30 weight % or more and 80 weight % or less, for example.

Examples of the conductive material include a carbon material. Examples of the carbon material include a particulate carbon material such as acetylene black (AB) and ketjen black (KB), and a fibrous carbon material such as carbon fiber, carbon nanotube (CNT), and carbon nanofiber (CNF). The ratio of the conductive material in the positive electrode active material layer is 0.01 weight % or more and 10 weight % or less, for example.

The thickness of the positive electrode active material layer is not particularly limited, and is 0.1 μm or more and 1000 μm or less, for example.

### 3. Negative Electrode Active Material Layer

The negative electrode active material layer contains at least a negative electrode active material.

Examples of the negative electrode active material include an Si-based active material. The Si-based active material is an active material that contains an Si element. Examples of the Si-based active material include an elemental Si, an Si alloy, and an Si oxide. It is preferable that the Si alloy contains the Si element as a main component. The ratio of the Si element in the Si alloy is 50 mol % or more, for example, and may be 70 mol % or more, or may be 90 mol % or more. On the other hand, the ratio of the Si element in the Si alloy is 99 mol % or less, for example. Examples of the Si alloy include an Si—Al alloy, an Si—Sn alloy, Si—In alloy, an Si—Ag alloy, an Si—Pb alloy, an Si—Sb alloy, an Si—Bi alloy, an Si—Mg alloy, an Si—Ca alloy, an Si—Ge alloy, and an Si—Pb alloy. The Si alloy may be a two-component alloy, or may be a multicomponent alloy that contains three or more components. Examples of the Si oxide include SiO.

Further, the Si-based active material may include a diamond-type crystal phase, may include a clathrate I-type crystal phase, or may include a clathrate II-type crystal phase. In the clathrate I-type crystal phase or the clathrate II-type crystal phase, a polyhedron (cage) including a pentagon or hexagon is formed by a plurality of Si elements. This polyhedron has a space capable of including metal ions such as Li ions, in the interior of the polyhedron, and therefore, can restrain the change in volume due to charge and discharge. Further, the Si-based active material may include a void in the interior of a primary particle. The void can restrain the change in the volume of the active material, and can restrain a crack of the negative electrode active material layer. The void ratio is not particularly limited, and is 4% or more and 40% or less, for example. Whether the primary particle includes the void and the void ratio can be confirmed by the observation with a scanning electron microscope (SEM).

The negative electrode active material layer may contain at least one of an electrolyte, a conductive material, and a binder, as necessary. The content about the conductive material and the binder are the same as the contents described in “2. Positive Electrode Active Material Layer”. Further, it is preferable that the negative electrode active material layer contains the solid electrolyte described in “1. Solid Electrolyte”, as the electrolyte. Further, as the electrolyte, another electrolyte may be contained. The contents about the ratio of the solid electrolyte and the other electrolyte are the same as the contents described in “2. Positive Electrode Active Material layer”.

The thickness of the negative electrode active material layer is not particularly limited, and is 0.1 μm or more and 1000 μm or less, for example.

### 4. Solid Electrolyte Layer

The solid electrolyte layer is a layer that is disposed between the positive electrode active material layer and the negative electrode active material layer, and contains at least a solid electrolyte. It is preferable that the solid electrolyte layer contains the solid electrolyte described in “1. Solid Electrolyte”.

Further, the solid electrolyte layer may contain another electrolyte. Examples of the other electrolyte include an inorganic solid electrolyte such as a sulfide solid electrolyte. It is preferable that the sulfide solid electrolyte contains sulfur(S) as a main component of an anion element.

It is preferable that the sulfide solid electrolyte contains the Li element, an X element (X is at least one kind of P, Sn, Al, Zn, In, Ge, Si, Sb, Ga, and Bi), and the S element. Further, the sulfide solid electrolyte may contain a halogen element such as F, Cl, Br, and I. Further, in the sulfide solid electrolyte, an O element may be substituted for some of S elements.

Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive values, and Z is one of Ge, Zn, and Ga), Li₂S—GeS₂, Li₂S—SiS₂—Li₃PO₄, and Li₂S—SiS₂—LiₓM_{Oy} (x and y are positive values, and M is one of P, Si, Ge, B, Al, Ga, and In).

Further, examples of the other electrolyte include an organic solid electrolyte such as a gel electrolyte, and an electrolytic solution. As the organic solid electrolyte and the electrolytic solution, there are materials that are conventionally known in the battery field.

Further, the solid electrolyte layer may contain a binder as necessary. The content about the binder is the same as the content described in “2. Positive Electrode Active Material Layer”. The thickness of the solid electrolyte layer is not particularly limited, and is 0.1 μm or more and 1000 μm or less, for example.

### 5. Other Configurations

It is preferable that the solid-state battery in the present disclosure includes a positive electrode current collector that collects electric current from the positive electrode active material layer and a negative electrode current collector that collects electric current from the negative electrode active material layer. Examples of the material of the positive electrode current collector include SUS, aluminum, nickel, iron, titanium, and carbon. On the other hand, examples of the material of the negative electrode current collector include SUS, copper, nickel, and carbon.

The solid-state battery in the present disclosure may further include a confining jig that gives a confining pressure in a thickness direction, to the positive electrode active material layer, the solid electrolyte layer, and the negative electrode active material layer. The confining pressure is 0.1 MPa or higher, for example, and may be 1 MPa or higher, or may be 5 MPa or higher. On the other hand, the confining pressure is 100 MPa or lower, for example, and may be 50 MPa or lower, or may be 20 MPa or lower.

### 6. Solid-State Battery

The kind of the solid-state battery in the present disclosure is not particularly limited, and is typically a lithium-ion battery. Further, the solid-state battery in the present disclosure may be a semi-solid-state battery, or may be all-solid-state battery. Generally, the all-solid-state battery is a solid-state battery in which all electrolytes constituting the solid electrolyte layer are inorganic solid electrolytes. Further, the solid-state battery in the present disclosure may be a primary battery, or may be a secondary battery, and preferably should be a secondary battery. This is because the secondary battery allows repetitive charge and discharge and is useful as an in-vehicle battery, for example.

For example, the solid-state battery is used as an electric power source of a vehicle such as a hybrid electric vehicle (HEV), a plug-in hybrid electric vehicle (PHEV), a battery electric vehicle (BEV), a gasoline vehicle, and a diesel vehicle. Particularly, it is preferable that the solid-state battery is used as an electric power source for driving the hybrid electric vehicle (HEV), the plug-in hybrid electric vehicle (PHEV), or the battery electric vehicle (BEV). Further, the solid-state battery may be used as an electric power source of a movable body (for example, a train, a ship, or an airplane) other than the vehicle, or may be used as an electric power source of an electric product such as an information processing device.

### B. Solid Electrolyte

In the present disclosure, it is possible to provide a solid electrolyte that is used in the solid-state battery. The solid electrolyte contains the Li element, the Al element, the M element (M is at least one kind of B, Ga, In, and Tl), and a halogen element, and contains the above halogen element as a main component of the anion. The contents about the solid-state battery and the solid electrolyte are the same as the contents described in “A. Solid-State Battery”.

The present disclosure is not limited to the above embodiment. The above embodiment is an example, and the technical scope of the present disclosure includes all embodiments that have configurations substantially identical to technical ideas described in the claims in the present disclosure and that exert the same function effects.

### Example 1

### Making of Solid Electrolyte

As raw materials, LiI and AlI₃ were weighed by a total of 10 g, and heptane was weighed by 100 g. They were put in a ball mill (size: 500 ml, used ball: 5 mm ZrO₂) manufactured by Fritsch, and ball milling was performed at 300 rpm for 20 h. Thereby, LiAlI₄ was obtained. Further, ball milling was performed using LiI and GaCl₃ as raw materials, similarly to the above description, so that LiGaI₄ was obtained. The obtained LiAlI₄ and LiGaI₄ were weighed at a mole ratio of 90:10, and ball milling was performed. Thereby, a solid electrolyte having a composition of LiAl_{0.9}Ga_{0.1}I₄ was obtained.

### Making of Battery for Evaluation

Using the above solid electrolyte, a solid-state battery shown in FIG. 1 was made as a battery for evaluation. A layer containing an Si-based negative electrode active material (elemental Si), a binder (PVdF-based binder), the above solid electrolyte, and a conductive material (VGCF) was used as the negative electrode active material layer. A layer containing a positive electrode active material (LiNi_{1/3}Co_{1/3}Mn_{1/3}O₂), a binder (PVdF-based binder), the above solid electrolyte, and a conductive material (VGCF) was used as the positive electrode active material layer. Further, a layer containing a binder (butadiene rubber) and the above solid electrolyte was used as the solid electrolyte layer. Further, an Al foil was used as the positive electrode current collector, and an Ni foil was used as the negative electrode current collector. Further, the battery for evaluation was confined at a pressure of 6 N.

### Examples 2-4

Solid electrolytes having compositions shown in Table 1 were obtained by mixing LiAlI₄ and LiGaI₄ at a mole ratio of 80:20, a mole ratio of 60:40, and a mole ratio of 20:80, respectively. Batteries for evaluation were made similarly to the example 1, except that the solid electrolytes were used.

### Comparative Examples 1-2

Batteries for evaluation were made similarly to the example 1, except that LiAlI₄ or LiGaI₄ was used as the solid electrolyte, instead of the solid electrolyte in the example 1.

### Reference Example

A battery for evaluation was made similarly to the example 1, except that a sulfide solid electrolyte (Li₂S—P₂S₅ sulfide solid electrolyte) was used as the solid electrolyte, instead of the solid electrolyte in the example 1.

### Evaluation

### Charge-Discharge Efficiency

For each battery for evaluation, a CCCV charge-discharge was repeated at a charge-discharge rate of 1/3 C at room temperature to 50 cycles. The ratio of the discharge capacity after 5 cycles with respect to the initial discharge capacity and the ratio of the discharge capacity after 50 cycles with respect to the initial discharge capacity were calculated as “charge-discharge efficiency”. The results are shown in Table 1.

TABLE 1

| | | | Charge-Discharge | |
|---|---|---|---|---|
| | | | Efficiency (%) | |
| | | M/(Al + | after 5 | after 50 |
| | Solid Electrolyte | M)(%) | cycles | cycles |
| Reference | Sulfide Solid | — | 93 | 86 |
| Example | Electrolyte | | | |
| Comparative | LiAlI₄ | 0 | 68 | 31 |
| Example 1 | | | | |
| Example 1 | LiAl_{0.9}Ga_{0.1}I₄ | 10 | 85 | 78 |
| Example 2 | LiAl_{0.8}Ga_{0.2}I₄ | 20 | 95 | 92 |
| Example 3 | LiAl_{0.6}Ga_{0.4}I₄ | 40 | 94 | 91 |
| Example 4 | LiAl_{0.2}Ga_{0.8}I₄ | 80 | 88 | 80 |
| Comparative | LiGaI₄ | 100 | 84 | 56 |
| Example 2 | | | | |

As shown in Table 1, the solid-state batteries in the examples 1 to 3 had higher charge-discharge efficiencies after 5 cycles, and particularly, had higher charge-discharge efficiencies after 50 cycles, compared to the comparative examples 1 and 2. Therefore, it was suggested that the decomposition of the solid electrolyte in the charge and discharge of the battery was restrained in the solid-state batteries in the present disclosure. Further, it is known that the sulfide solid electrolyte used in the reference example is a solid electrolyte that makes it hard for oxidation-reduction reaction to occur and that has a high ion conductivity. However, the sulfide solid electrolyte tends to have a low water resistance because sulfur is contained. In contrast, for the solid-state batteries in the examples 1 to 3, it was confirmed that charge-discharge efficiencies comparable to that of the solid-state battery in the reference example were exhibited, and it was suggested that water resistances also were high because the sulfur element was not contained.

What is claimed is:

1. A solid-state battery comprising:
a positive electrode active material layer;
a negative electrode active material layer; and
a solid electrolyte layer that is disposed between the positive electrode active material layer and the negative electrode active material layer, wherein:
at least one of the positive electrode active material layer, the negative electrode active material layer, and the solid electrolyte layer contains a solid electrolyte; and
the solid electrolyte contains an Li element, an Al element, an M element (M is at least one kind of B, Ga, In, and Tl), and a halogen element, and contains the halogen element as a main component of an anion.

2. The solid-state battery according to claim 1, wherein a ratio of the M element to a total of the Al element and the M element is 10% or more and 80% or less, in the solid electrolyte.

3. The solid-state battery according to claim 1, wherein the solid electrolyte contains an I element as the halogen element.

4. The solid-state battery according to claim 1, wherein the negative electrode active material layer contains an Si-based negative electrode active material.

5. A solid electrolyte that is used in a solid-state battery, wherein the solid electrolyte contains an Li element, an Al element, an M element (M is at least one kind of B, Ga, In, and Tl), and a halogen element, and contains the halogen element as a main component of an anion.
